(19) United States
(12) Patent Application Publication
(10) Pub. No.: US 2007/0047522 A1
(43) Pub. Date: Mar. 1, 2007

(54) Method of and System for Telecommunication Management

(75) Inventors: Todd Jefferson, Manotick (CA); Yanick Dufresne, Ottawa (CA); Andrew Hackston, Ottawa (CA); Noam David Tomczak, Ottawa (CA); Alec Saunders, Manotick (CA); Howard H. Thaw, Green Valley (CA)

Correspondence Address: BUCKINGHAM, DOOLITTLE & BURROUGHS, LLP, 3800 EMBASSY PARKWAY, SUITE 300, AKRON, OH, 44333-8332, US

(73) Assignee: Iotum Corporation, a Delaware corporation, Ottawa (CA)

(21) Appl. No.: 11/382,142

(22) Filed: May 8, 2006

(30) Foreign Application Priority Data
May 6, 2005 (CA) 2,506,665

(51) Int. Cl. H04L 12/66

(52) U.S. Cl. 370/352

(57) ABSTRACT

The present invention relates to telecommunication systems and more specifically, to a method of and system for managing and routing calls and/or data between various devices. The invention includes a method of routing real-time communications including the steps of: obtaining rule preferences from a user, and responding to the receipt of a communication by determining the current contextual state of the user. The method then determines how to route the communication with respect to the current contextual state of the User and the User's rules, and routes the communication in accordance with that determination.

### FIELD OF INVENTION

The present invention relates to telecommunication systems and more specifically, to a method of and system for managing and routing calls and/or data between various devices

### BACKGROUND OF THE INVENTION

The architecture of the traditional voice communication network, the public switched telephone network (PSTN), has been merging with the Internet and is driving a sweeping set of changes in communication services. IP (Internet Protocol) Communications refers to the integration of data, voice, call management and video solutions onto a single, Internet Protocol based network. IP Communications has radically changed the way people communicate, and the way telecommunication networks operate.

Voice over IP (VoIP) technology, for example—the transmission of voice as packets over IP networks—is a major step in the transformation of the communications industry currently underway. VoIP is opening the door to smart communication devices that are transforming the communications experience. Users are becoming able to access diverse media, including voice, e-mail, instant messaging, Web sites, video, applications and data, not only from their desktops and notebooks, but also from cell phones, desk phones, personal digital assistants (PDAs), entertainment devices such as set top boxes and other similar devices. However, the new functionality is also introducing new problems and new user expectations that are difficult to manage.

As functionality increases, smart devices are supporting more intuitive interfaces, cross-network access, and seamless device-to-device communications to enable a simpler and more unified end-user experience. As information flows more freely, people require more intelligent control over how the communication flows so they can spend more time communicating and less time managing communications.

The architecture of the voice network is merging with that of the Internet, and driving a sweeping set of changes in voice services. As the architecture of the network shifts to the IP (internet protocol) platform, voice is moving from a set of vertically integrated services and products to componentized, unbundled, services and products. Industry watchers are comparing this shift to the introduction of the personal computer. Nowhere is this more apparent than in the enterprise market, where voice is moving from a standard-alone and proprietary environment to an integrated, horizontal infrastructure application dependent on enterprise assets like PC's, servers and data networks.

Initially, this shift is being driven by economics. As companies move away from traditional PBX architectures, the savings are dramatic. For instance, IBM replaced 900 expensive PBXs with 10 servers, and outsourced PSTN connections saving themselves millions of dollars in the process.

The next step, to realize the fill benefit of VoIP, is the integration of new voice applications, built on the VoIP infrastructure, into business processes directly.

The market needs driving the invention are:
The need to support “Always-On” business,
The need to unify disparate systems, and
The need to overcome the limitations of proprietary systems.

There is therefore a need for a system and method of telecommunication management that can provide intelligent management of communications so that users can spend more time communicating and less time managing their telecommunications This system should be dynamic and provide the user with controls to dictate how he would like to implement his system.

### SUMMARY OF THE INVENTION

It is therefore an object of the invention to provide an improved method of and system for telecommunication management which obviates or mitigates at least one of the disadvantages described above.

The invention provides a communication management system and method that leverages industry standards to create a contextual communication environment, enabling users to limit interruptions by diverting real-time communications that are irrelevant to their current activity. For individual professionals and small businesses that need to manage many communications in a day, the invention ensures that you do not miss important communications, and are not interrupted by communications which are not relevant to your immediate business needs.

Competitors in the industry sell presence as the solution, leaving all of the control of the call in the hands of the calling party While presence is important, it has been found that it is not the whole solution

Unlike find-me-follow-me solutions, or personal assistant applications, which route telephone calls to you with very little intelligence, the invention allows users to define rules for controlling all manners of real time communications based on a number of contextual criteria including:
Presence;
Day and Time;
relationship to the caller (for example, the authentication level of the calling party);
Current activity;
Who is calling;
What the call is about;
Importance of the call;
PC activity;
Communication history with caller;
Velocity of user (driving, running etc.);
Refer information (whether the call is being transferred by someone else);
Mood of user;
Ambient noise; and
Location of user (can, for example, be implied by the device used, such as a desktop telephone, be determined by the base station that a portable device is communicating through, using GPS, by triangulation or other technologies.)

Physical presence alone is not context. The less contextually aware, the less automated control can be. Knowing the physical presence state of a contact is a first step, but contextual awareness requires a lot more than physical presence. Contextual awareness is the set of facts or circumstances that surround a situation. Contextual awareness represents the awareness of the applications of the context based on factors including: physical presence, day and time, current activity, who is calling, what the call is about, environment, place, relationship and caller preferences. Users can define rules for managing telecommunications based on a number of contextual criteria.

For example, a user may be in a meeting with a co-worker. He may wish to be available to his boss or other co-workers, but wish to avoid being interrupted by his friends outside the company. He may wish to be available to closer personal contacts such as his spouse, provided that the matter is urgent enough to warrant interrupting the meeting with the co-worker. The system of the invention takes into account all of these factual details and applies them to the user's set of rules to determine whether he should be interrupted, and if so, in what manner.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 presents a block diagram of the VoIP Landscape;

FIG. 2 presents a diagram of development of call control v contextual awareness of existing technology;

FIG. 3 presents a block diagram of an exemplary call control scenario in an embodiment of the invention;

FIG. 4 presents a block diagram of an exemplary system of the invention;

FIG. 5 presents a block diagram of an exemplary architecture for a server in an embodiment of the invention;

Table 1 presents an exemplary feature to element mapping in an embodiment of the invention;

Tables 2 and 3 present exemplary user cases in embodiments of the invention;

FIG. 6 presents an exemplary client interface fox the development of call control rules in an embodiment of the invention;

FIG. 7 present a process flow diagram for an incoming call use case, in an embodiment of the invention;

FIG. 8 presents a system diagram for initiating a call, in an embodiment of the invention;

FIG. 9 presents a process flow diagram for the viewing and editing of rules, in an embodiment of the invention;

FIG. 10 presents a process flow diagram for process context updates from a wireless device, in an embodiment of the invention; and

FIG. 11 presents a process flow diagram for administrative console interaction, in an embodiment of the invention.

### DESCRIPTION OF PREFERRED EMBODIMENTS OF THE INVENTION

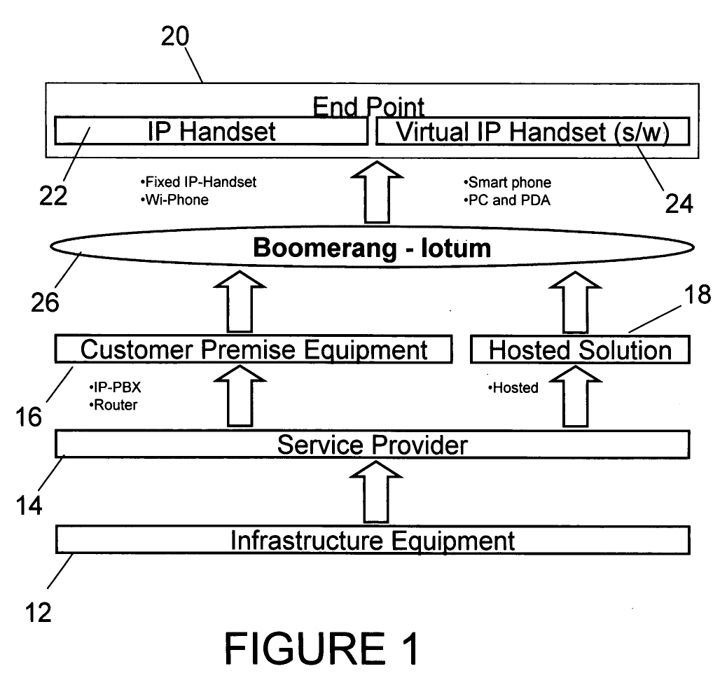

The above described problems can be addressed by employing a system and method as described hereinafter and presented in FIGS. 1 through 11, and Tables 1 through 3.

As explained above, the system of the invention collects context information regarding a User's available communication channels, and uses rules established by the User to determine how to manage the User's communications, both outgoing and incoming.

For example, suppose that incoming caller Joe is on subscriber Jane's VIP list, but incoming caller Stan is not Further, Jane's calendar indicates she is currently in a meeting. Jane's rules may require that when her calendar shows her in a meeting, she is busy, but allows VIPs to interrupt her. Thus:
1) Joe's call may be directed to Jane's cellular telephone, even though Joe had dialed the number for Jane's desktop telephone; while
2) Stan's call will be routed to voicemail, regardless of whether he dialed the number for Jane's cellular telephone or desktop telephone.

The invention is described with respect to particular examples, but it will become clear that the invention may be implemented on various platforms. For example, it may be centered around a server, client, web application, ASP (application service provider), integrated with another device such as a VoIP telephone or PBX card, or provided as a separate, stand-alone system. Each has its own advantages and disadvantages, and the decision on which to use will generally change with the situation of the user.

A presence server can also be implemented in any number of ways, for example, building on SIMPLE and SIP, other standards currently available, or other standards which are developed over time. SIMPLE (session initiation protocol for instant messaging and presence leveraging extensions) is an application of the SIP protocol for server-to-server and client-server interoperability in instant messaging. SIP (session initiation protocol) is an application layer control protocol signaling protocol for Internet Telephony. It is used to establish audio and video connections, call forwarding and other fundamental telephony features It would be clear to the person skilled in the art that the invention is independent of any of these particular tools used in its implementation.

When the user updates some of their context information or rules, or the context information is automatically updated due to some outside influence, the manner in which a communication is managed may change. For example, if the user goes into a meeting as recorded in his Microsoft Outlook Calendar, the system may determine that a given caller may interrupt the user because he is on the VIP list, but other caller's may now be routed to voicemail (because they are not on the VIP list).

The gathering of user context information will be performed both automatically and manually. For example, the user may be able to manually click on a box in a graphic user interface (GUI) which reads “do not disturb”, while he is having lunch or is participating in an ad hoc meeting with his boss. He may also click on various manual overrides such as: available, busy, busy but interruptible, do not disturb, out of the office, or on vacation.

As well, context information may be collected automatically from various sources such as:
meetings recorded in Microsoft Outlook;
checking the time of day either online, or on a local clock;
determining the subscriber is physical location;
collecting presence status from other services;
accessing stored lists of acceptable Watchers in subscriber's groups; or
Ambient environmental information such as noise, conversation, temperature etc.
   Typically, the information will be collected using add-ons, software modules which are added to existing applications to provide access to the data that they require. Microsoft Exchange, Yahoo Messenger, MSN Messenger and MS Outlook are all current applications from which contextual data may be obtained.

The User also configures his rules/behaviors for assessing any incoming inquiries. Any number and variety of rules may be established to configure the system, and of course, the rules will vary with the nature of the communication medium. An exemplary set of rules is as follows:
If someone I am meeting with today calls, send the call to my preferred phone
If a member of the Family group calls outside work hours, send the call to my preferred phone.
If a member of the Clients group calls during work, send the call to my preferred phone.
If a member of the Co-Workers group calls during work, send the call to my preferred phone.
If a member of the Friends group calls during the evening or on the weekend, send the call to my preferred phone.
If a member of the Blocked group calls, decline the call
If a member of the VIP group calls, send the call to my preferred phone.
While I am in a meeting, send the call to voicemail.
While I am busy, send the call to voicemail.
During the night, send the call to voicemail.
While I am away from my desk, make my mobile phone my preferred phone
When I am mobile, make my mobile phone my preferred phone.
When I am at work, make my work phone my preferred phone.
When I am at work, make my work phone my preferred phone.

It is preferable that the system architecture be designed to accommodate both beginners and experienced programmers. For example, the invention will be implemented with a software wizard which steps the user through the available options and has help support. At the same time, more experienced programmers will have the option of generating their own rules, using a scripting language or some similar tool

The rules in the wizard will generally be established to reflect the most common scenarios and devices. Wizards dedicated to particular industries, professions and hardware systems can be generated and provided with the system. For example, if the user only has connectivity to two or three specific communication systems, it is not logical to present a long list of rules to them regarding other communication systems.

Once the initial context information has been collected and the user rules established, the system may process incoming real-time communications. Each incoming communication will be assessed with respect to the context and rules, and a determination made as to how to handle the communication. This analysis may be performed in several different ways (heuristics, artificial intelligence, neural networks, Bayesian networks, fuzzy logic etc.), but it is preferable to use an “expert system” model as known in the art. The parameters used in the various analysis techniques are described as rules, behaviours, actions, policies, preferences or other similar language, whichever is appropriate to the analysis technique being used. Rather than repeating the listing of the various parameters each time, these are all referred to collectively as “rules” hereinafter. It is understood that the invention is independent from the specific analysis engine being employed in a given embodiment.

Advanced heuristics algorithms can also detect communication routing patterns, so that common user contacts and preferences can be determined, and dialing and typing errors brought to the user's attention. Pattern detection can also be used to automatically (with user's consent) modify the user's rules to improve the communication handling Identifying the relationships between known callers and their associations allows a “social networking” system to be developed.

As the technology in respect of heuristics and artificial intelligence grows, the invention can employ those technologies to make more intelligent communication routing decisions.

A hierarchy concept of rules and policies that allow for global and individual rules processing For example, it may be a matter of corporate policy that all emails be sent to a central location if the intended user is not at his computer. This would be implemented as a rule at a administrative level that individual users cannot override.

It is also important in designing the rules engine to handle conflicts between rules in such a way that they default in a safe manner, rather than dropping a communication or causing a software error.

The User may also request that his rules/behaviours/actions be changed. In such a case, the rules wizard is launched again, but as a default, fields of the wizard are populated as per the User's original data. The User is able to make whatever changes he requires and store the new set of rules. The user may also create advanced custom rules/behaviors/actions using a rule editor UI that allows for more advanced functionality than the setup wizard

The system and method of the invention carves out a unique space in the industry. The contextual awareness it provides adds value to any SIP compliant end point (IP phones, soft-phones) and it can add value to IP-PBXs as well. As a result, it can leverage partnering opportunities from both of these industry sectors rather than competing with them.

As noted above, the IP PBX market is exploding. In 2005, for the first time, sales of IP PBX stations surpassed traditional PBX By 2008 nearly 16 million IP PBX “lines” and another 1.2 million hosted IP PBX lines will be sold annually. The IP PBX market is a replacement market for existing PBX installations, whereas the hosted market is an emerging outsourced PBX model to be delivered by carrier's to small business customers.

A primary target market for the invention is small and medium business, defined as those businesses with under 50 seats. These businesses account for 38% of the IP PBX market, or 6.5 million seats, and $5 billion, annually.

Market Segmentation

Small businesses can be neatly organized using activity based segmentation. There are 4 main activity segments:
Office Services: provide customers with personal services in their offices and do not sell product
Order Fillers take, process and ship orders for physical goods, and focus on customer service and relationships for their success.
Field Services are primarily mobile businesses that provide customers services in the field, rather than from within an office. This segment represents 24% of the market.
A-Z companies execute all aspects of business (from manufacturing to marketing and sales), and find each aspect of the business critical to their success.

The emphasis on real-time communication routing and handling, makes the Office Services and Order Fillers segments the primary target. This represents 39% of the small business market, or a potential market of approximately 16 million seats.

Drivers—What Clients Need

Three major categories of drivers are making the development of a product like that of the invention highly desirable:

1. Always-On Business

Many businesses today, must be responsive to communications every day of the week, at any time of day. This is referred to as “Always-On Business” Our service driven society demands it in order to maximize customer satisfaction and employee productivity, to be responsive to international clientele, and to be responsive to clients who work outside of regular local business hours.

Always-On Business has lead to a proliferation of communications methods and technologies, and a culture where interruption is taken for granted. The downsides of being Always-On are (paradoxically) the development of a productivity gap, and increasing caller dissatisfaction when the person a caller seeks cannot be found. The invention addresses these issues.

The business needs in an Always-On Business world are:
1. Increased employee mobility and productivity
2. more intelligent call handling
3. greater organizational flexibility
4. new ways to communicate with third parties

There are a number of problems associated with Always-On Business:
I have to be available everywhere,
Nobody knows how to find me,
When focusing on a task, I am often interrupted by irrelevant calls

2. Unified Systems

A prevailing business sentiment is that corporations have too many disparate systems, and too much infrastructure as a result. A side effect of this is that companies simply have too many silos of functionality, and nothing works well together.

Since the beginning of business, managers have always sought to do more with less. In today's post-9/11, post-techwreck world, however, this imperative has never been clearer.

As markets contracted following 9/11, businesses were faced with rigorous cost-cutting requirements as sales retrenched. Unifying disparate systems into a single cohesive infrastructure improves efficiency, reduces maintenance and as a result, reduces costs.

Businesspeople require a number of business tools, but these tools do not work well together. Even when integrated on a single network, applications are frequently islands of functionality separate from other line of business applications. As one Fortune 100 VP put it, on a good day:
My PC works
My IM works
My audio conferencing works
My applications work
My phone works
My cell phone works
My PDA works
Everything works—but none of them work well together. The invention addresses this issue.

3. Open Standards

Businesses have come to expect improvements from the application of open standards based on the benefits tat have been realized by applying them in the IT and Internet sectors However, to-date the telecom industry has been slow to embrace open standards.

Traditionally PBX's have been vertically integrated proprietary solutions Reduced choice, increased cost and single-vendor dependency introduce increased risk, and inefficiency due to a lack of interoperability.

The Landscape

The block diagram of FIG. 1—VoIP Landscape depicts the major elements in the VoIP value chain:
Infrastructure Equipment 12 provides infrastructure, both hardware and software that are key to the viability of VoIP as a replacement for traditional telephony. This market has become fairly well established
Service Providers 14 include flee services such as Peer to Peer applications like Instant Messaging and quality assured services that support enterprise customers. Providers include new IP Telephony only providers, cable operator's, ISPs and traditional telephony providers who have begun to offer VoIP as an alternative service.
Customer Premise Equipment (CPE) Provider's 16 manufacture equipment that is required on the customer premises, for both consumer and enterprise customers. Most of the player's in this part of the market are established IP networking providers who have extended their product ranges On the enterprise side, equipment includes IP PBX systems.
Hosted Solutions providers 18 deliver software to carriers that implement IP-PBX functionality on a rental basis to small businesses.
Handset Providers 20 include two main sub-groups, hardware handset providers 22 and virtual or software handset providers 24.

The system of the invention 26 is interoperable with the Customer Premises Equipment 16 and hosted providers 18 and is intended to run on top of the basic call control platform. It interfaces with telecommunication devices 20 and integrates with other productivity applications.

Industry Category Mapping

The VoIP industry is fragmented but growing rapidly. This environment is enhancing competition, with players seeking new opportunities for growth that extends their leverage.

The two criteria used to map this enhanced competition are:
Real-time communication control, which represents the control that the user has over their communication, based on the level of interruption; and
Context Awareness, which is the set of facts or circumstances that surround a situation. As described above, contextual awareness represents the awareness of the applications of the context based on: Time, Identity, environment, activity, place, relationships, caller preferences and other similar parameters.

The results of the category analysis are illustrated graphically in the VoIP category maps below.

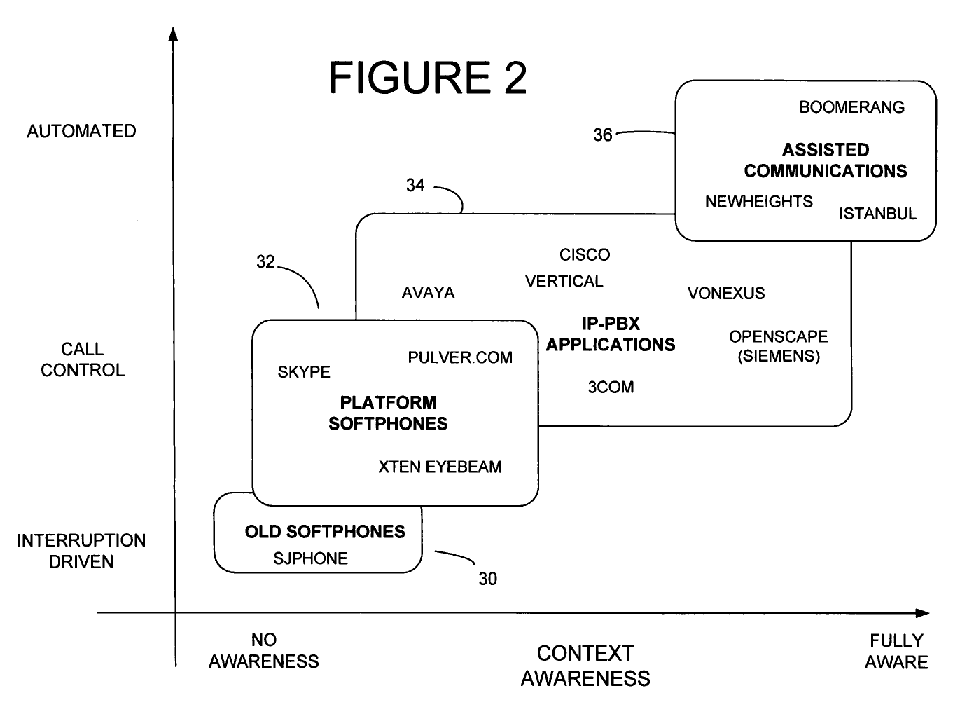

The block diagram of FIG. 2—Communication Management Application places the various categories of products in the IP Communications Market.

On the lower left are two categories of softphone products, reflecting the evolution of softphones. First generation softphones 30, such as Sjphone, are beginning to be replaced by products that offer platform capability 32, such as Skype, Pulver and Xten eyebeam The softphone is evolving into a platform component for integrating applications on the desktop.

In the center of the map are PBXs 34, which have always been applications platforms, such as products offered by Avaya, Cisco, Vonexus, 3com and OpenScape However, traditional PBX platforms, and many of today's generation of IP PBX platforms, assume the use of a “dumb” endpoint As these products evolve more and more of the capabilities of the end point are being exploited, such as presence

At the far right of the map are Assisted Communications applications 36. These applications are client server applications which assume intelligent end points, and highly programmable PBX capabilities. These are the future of IP Communications.

Soft-phones

The soft-phone industry is still young and developing. Leaders in the market implement open standards like SIP that allow interoperability. The most advanced products are evolving towards a communication platform. Continuous addition of features, especially presence modules, and integration with other common applications makes soft-phone manufacturers potential competitors. However, soft-phones simply provide a tool to communicate without the control. They do not soothe the pain associated with an interruption driven world.

As seen on the industry map, soft-phones have really turned a corner. Until recently softphone vendors had focused on duplicating telephone functionality. Some vendors have begun to move towards completely new business models that are forcing the entire sector to react.

The system of the invention is not a SIP endpoint, but is rather an application that can provide contextual awareness to any SIP endpoint, including soft-phones.

IP-PBX Vendors

IP PBXs are the most complete small business telephony offerings and will see steady growth. As observed in the market analysis, sales of IP enabled PBXs are expected to exceed those of traditional PBX in 2005. IP enabled PBXs are convergence products designed to exploit the potential of single network merged data and voice. These manufacturers are also developing software that exposes the basic call control capabilities of their underlying platform.

This market will shift away from proprietary architectures and move decisively to SIP, despite the fact that most of the vendors today are delivering either proprietary MGCP or H.323 solutions. Furthermore, open architectures based on SIP will cause the market to segment to provide two main functions: i) a basic call control platform and ii) an application development layer that enables “a la carte” applications to run on top of their platform.

IP-PBX are competing to gain control of the collaboration desktop and they are developing context awareness by integrating with other applications. The race for the desktop is forcing the IP-PBX suppliers to continually add calling features that tie in with other applications, however little emphasis is being placed on control.

The contextual awareness that the system of the invention provides compliments the direction underway by the IP-PBX manufactures and the use of open standards facilitates interoperability. As is the case for soft-phones, the system of the invention provides a value add for IP-PBX manufacturers and makes them ideal partnering candidates as well.

The system of the invention carves out a unique space in the industry. The contextual awareness it provides can add value to any SIP compliant end point (including soft-phones) and it can add value to IP-PBXs as well. As a result, it can leverage partnering opportunities from both of these industry sectors rather than competing with them.

Assisted Communication

Assisted communication is a new segment. Players in this segment enable context awareness mostly through presence but with input from other context sources as well. The focus in this segment of the market is context and user empowerment, the goal being to help the user control their level of interruption by providing automated control of calls.

Even as the IP communications market slowly moves in this direction, this segment is clearly ahead of the game. This segment will turn the telecommunication industry upside down. Strategic alliances with IP-PBX manufacturers or internal diversification will make assisted communication a huge growth sector in the VoIP industry.

The invention has a completely new approach in this space. Instead of focusing on availability and increasing communication, it cures the pain of interruption. Much like an email spam filter, the focus is on making sure relevant calls reach the end user, not every call.

The main competitors in this space sell presence as the solution, leaving all of the control of the call in the hands of the calling party. Presence is part of the invention, but not the whole solution.

First, without automated control of the call, presence is just a source of information the caller can consult to adapt his behavior. This represents a negligible reduction in interruptions. Second, Presence alone is not context. The less context aware, the less automated control can be. Knowing the presence state of a contact is a first step, but as described before, context awareness requites a lot more than presence.

Soothing the Pain—What Makes the Invention Special

1. Always-On Business

The system of the invention addresses the pain associated with “Always-On” business by providing a contextual communications environment that enables users to set up rules for controlling calls. Calls from authorized individuals are routed directly to the user wherever they may be, while other calls are blocked or redirected to a destination defined by the user. Different rules can be defined for various contexts (Busy at work, Available at home). The invention tracks the user's context and invokes the appropriate rule set.

2. Unified Systems

The system of the invention addresses the pain associated with disparate systems by integrating the functionality of existing business applications and by using this functionality to help all of the business tools work together. The data stored in a calendaring application can trigger Boomerang to invoke a user defined call control rule that routes calls from authorized individuals to the appropriate device so that the user can always be reached directly, while other calls are blocked or redirected to a different destination.

3. Open Standards

The invention addresses the pain associated with proprietary systems by leveraging, contributing and influencing SIP and other open standards. Systems built on open standards mitigate the issues associated with proprietary systems while simultaneously providing an open platform for integration of systems within the organization.

Part II—Product Roadmap

For individual professionals and small businesses who need to manage many calls in a day, the system of the invention provides IP communications software that ensures that you never miss an important call, and that you are never interrupted by calls which are not relevant to your immediate business needs. Unlike find-me-follow-me solutions, or personal assistant applications, which route calls to you with very little intelligence, the invention uses IP communications technology and your current context (who is calling, why they are calling, how important that call is to you, what you are currently engaged in, where you are, time of day, and other factors) to automatically determine whether to route the call to you, your voice mail, an assistant, or a message.

The system of the invention can, for example, be set up as client/server call control software that leverages industry standards to create a contextual communication environment, which enables the user to manage and control SIP calls. As noted above, SIP (Session Initiation Protocol) is the industry standard for establishing communication over IP, including Voice over IP (VoIP). In addition to SIP, the system of the invention can support a XML-RPC based call processing interface. This allows any SIP or non-SIP network switch elements and IP PBXs to utilize the Boomerang server for routing calls

The system of the invention provides the means for enabling said End User to set up rules for governing communications using a personal computer. When used with an IP infrastructure, SIP helps to enable rich communications with numerous multi-vendor devices and media SIP can set up individual voice or conference calls, videoconferences and point-to-point video-enabled calls, Web collaboration and chat sessions, or instant messaging sessions between any number of SIP enabled endpoints, including IP phones, PCs, laptops, personal digital assistants (PDAs), and cell phones.

In a client/server software implementation, the Boomerang server is always on. Managing SIP calls enables a Boomerang user to identify individuals with whom they are willing to engage in direct personal communication, and to define how calls are handled in general Boomerang's SIP control capabilities provide the mechanism for handling SIP calls according to the user's management preferences—calls from authorized individuals are routed directly to the user wherever they may be, while other calls are blocked or redirected to the destination they defined

The system of the invention integrates with familiar business applications. The integration enables the applications to share and exchange data. For example, it can access the address book features of a third party application to make it easier for the user to establish outgoing calls and to identify the source of incoming calls. It can also access calendaring features of another application to invoke different call control schemes defined by the user.

The use of open standards makes it possible for Boomerang to interoperate with any SIP compliant end point (including soft-phones) and IP-PBXs as well The contextual awareness that it provides compliments both of these market sectors and provides it with a unique position in the industry—Boomerang can leverage partnering opportunities from both of these industry sectors rather than competing with them.

The system of the invention provides a contextual communications environment that enables users to limit interruptions by diverting calls that are irrelevant to their current activity. Calls from authorized individuals are routed directly to the user wherever they may be, while other calls are blocked or redirected to a destination defined by the user.

Boomerang users define rules for controlling calls based on a number of contextual criteria including:
Presence;
Day and Time;
relationship to the caller (for example, the authentication level of the calling party);
Current activity;
Who is calling;
What the call is about;
Importance of the call;
PC activity;
Communication history with caller;
Velocity of user (driving, running etc.);
Refer information (whether the call is being transferred by someone else);
Mood of user;
Ambient noise; and
Location of user.

Boomerang continuously monitors the user's contextual state and automatically invokes the appropriate call control rules defined by the user. Monitoring contextual criteria is accomplished in a number of ways. Context criteria can be updated automatically through collaboration with calendaring features of existing business applications, and by monitoring SIP messages. The user can also change context manually.

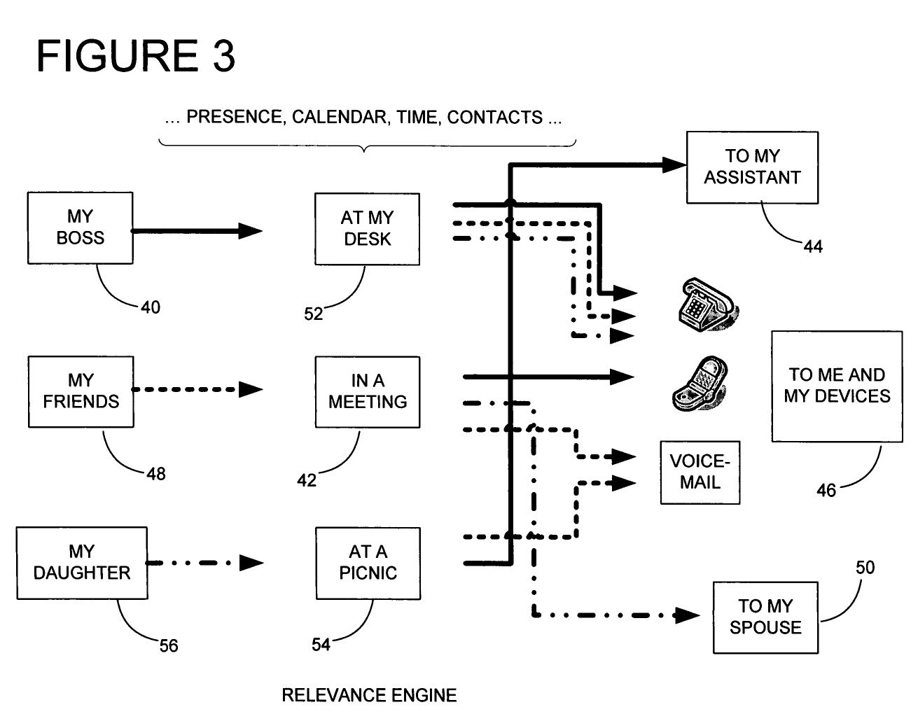

FIG. 3 presents a process flow diagram of Boomerang call control in action. If the boss 40 calls regarding an important report and the user is in a meeting 42 or out of the office 54, the call would be routed to the assistant 44, while if the user is at his desk 52, it will be routed to his devices 46 If a friend calls 48, the call will typically be forwarded to the user's devices 46, but not to his assistant 44 or spouse 50. If a member of the user's family calls 52 and that user is out of the office 54, the call may be routed to his spouse 50. In each of these cases, Boomerang is basing call routing on the user's current context and the rules and policies that have been created.

Call control rules are defined through a simple user interface. Furthermore, the rules definition interface can integrate address book features from existing business applications to make rules creation even easier.

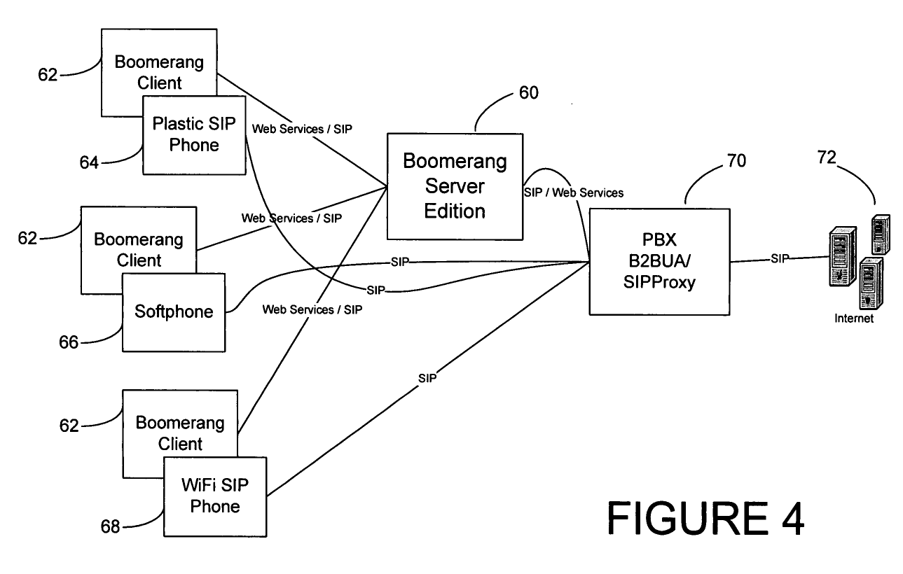

A high level overview of an exemplary system of the invention is presented in FIG. 4 As shown, Boomerang consists of a server 60 and a PC (personal computer) based client 62 The Boomerang client 62 is a desktop PC application which:
1) allows the user to specify rules for given call contexts;
2) interfaces desktop context information to the Boomerang server; and
3) performs call control between a third party phone device or software, and various local devices 64, 66, 68.

The Boomerang server 60 is the engine of the system. It aggregates context information, and routes calls based on that information. Communications between the Boomerang server 60 and Boomerang clients 62 is generally performed using various web services protocols and SIP. Communications between the Boomerang clients 62 and the local communications devices such as plastic SIP phones 64, softphones 66, and WiFi SIP phones 68 is generally via SIP. As shown, the local communications devices 64, 66, 68 may also communicate directly with a local IP PBX 70, which in turn, is connected to the Internet 72.

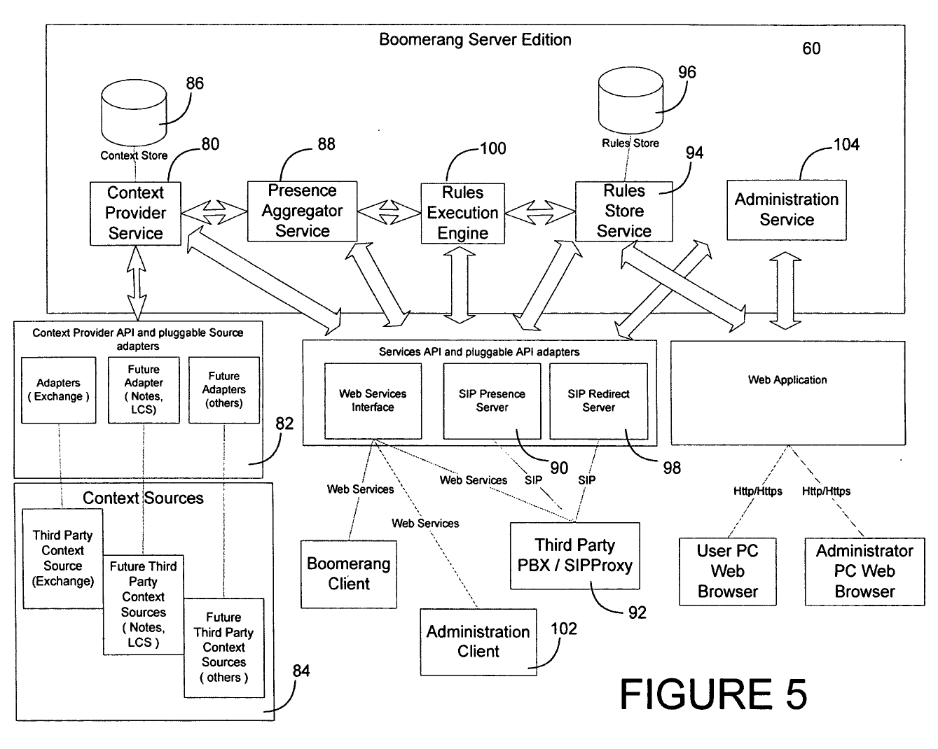

The server architecture in an embodiment of the invention is presented in FIG. 5. The Boomerang Server 60 is constantly monitoring and/or being updated with the users' context sources (for example, their calendar in Exchange) for relevant changes. The Context Provider Service 80 exposes context from heterogeneous sources in a consistent manner, so other services can easily get access to relevant context information. Potential context sources include email, contacts, calendar, time-of-day, presence clouds like Microsoft Live Communications Server, LDAP directories, and location services. The Context Provider Service 80 uses Adapters 82 to communicate with the different context sources 84. Adapters 82 are software components that have specific knowledge of the source of context that they access and retrieve Some of the context related information is cached in the Context Store 86 in order to improve performance.

The context information is used by the Presence Aggregator Service 88 to determine the user's effective presence, the Presence Aggregator Service 88 acting as a presence source, exposing the user's presence to the presence cloud, based on heuristics and context data. For example, when a user's calendar indicates that they are currently in a meeting, Boomerang would automatically update the user's presence to reflect that they are busy Boomerang achieves this by accessing the calendaring information using the adapter for that source of context. The current presence is published to the outside world using a SIP Presence server 90. The granularity of the presence data exposed to external SIP users 92 is controlled through privacy policies.

Using the Boomerang Client 60, the user would add, delete or edit rules that determine how incoming calls are handled. These rules use the user's current context and the caller information to determine what action to take (e.g. Accept, decline or redirect the call). Using the rules editor interface, the user can add, modify, delete and prioritize rules to control calls.

Using the Boomerang Rules Editor the user can specify what to do when a call arrives based on the evaluation of one or more conditions. These conditions can be selected based on who is calling, the time of day, the day of the week and other similar contextual sources of information The rules editor is used to add, delete, modify and prioritize the rules in effect for that user.

The Boomerang client 62 communicates with the Rules Store Service 94 on the server (using web services) where all rules data is stored. Rules data may be cached in the Rules Store 96 to improve performance. An example that illustrates how Boomerang's client is used to define call control rules appears hereinafter.

When a call comes in, the SIP Redirect Server 98 receives the INVITE and passes the information from the INVITE (e.g display name, uri, subject) to the Rules Execution Engine 100. The Rules Execution engine 100 requests current presence information from the Presence Aggregator Service 88 and rich contact information from the Context Provider Service 80. Using the current context, the rich contact information and the database of rules, the Rules Execution engine 100 responds to the SIP Redirect Server 98 which sends the appropriate SIP response to the INVITE.

Finally, the Boomerang Server 60 is configured from the Administration Client 102. The Administration Client 102 communicates with the Administration Service 104 using web services. The Administration client 102 allows the system administrator to setup users and configure the various sources of context information. A more detailed description of the technical “how to” expressed in the form of use cases is included hereinafter.

The system of the invention provides a contextual communications environment that enables users to limit interruptions by eliminating calls that are irrelevant to their current activity Calls from authorized individuals are routed directly to the user wherever they may be, while other calls are blocked or redirected to a destination defined by the user.

The Features

Call control based on contextual awareness is a core feature for Boomerang. Contextual awareness can be derived from a number of inputs. There are a number of systems that Boomerang can interface with in order to obtain the contextual data it needs, such as MSN Messenger and MS Outlook.

The invention allows callers to locate people who are available, so that they can quickly make communication connections, and avoid attempting to contact people who are unavailable or interrupting people who are busy with higher priority tasks. It also allows called parties to advise on the most convenient way to contact them at a given point in time. For example, if the individual is driving a car, they may wish to indicate that they are available via their hands-flee cell phone, but not via wireless email, even though they are using the same physical device for both. Thus, a person wishing to reach them will be directed to the most likely avenue for teaching that person, making that person easier to contact.

The invention allows callers to identify who is available and what medium to use to reach them. Thus, they can make the contact that they need, and the called parties are not interrupted when they are busy with more important tasks Employers can also audit the availability patterns of their employees to determine whether their clients are being properly accommodated.

As noted above, the invention can be supported at virtually any level in any telecommunication system as it is simply a new and complementary layer. The contextual awareness it provides would add value to any SIP compliant end point (IP phones, soft-phones) for example, or any IP-PBXs

The Internet is currently the most effective medium for the ultimate transmission of the presence information to calling parties, but that is simply because the Internet currently offers a pervasive, rich, real-time interface. If another communication medium was to overcome the Internet in respect of these advantages, the invention could easily be ported to it.

The method could, for example, be implement on a client, a server, an ASP, or as a separate physical box. In the case of implementation on a traditional PBX (private branch exchange), one could add a physical card to the PBX to monitor the status of the PBX users and provide this data to the Internet. The presence analysis could be run on the physical card itself, the card acting as a web server for reporting to Watchers over the Internet, or the analysis could be run on a separate server or via an ASP.

The invention is interoperable with all manners of telecommunication devices and related productivity applications including Customer Premises Equipment, hosted providers, softphones, IP-PBX phones and assisted communication systems. Assisted communication systems are client server applications which assume intelligent end points, and highly programmable PBX capabilities. The invention can also be implemented with any number or manner of end devices including SIP enabled endpoints, IP phones, PCs, laptops, personal digital assistants (PDAs), and cell phones.

Assisted communication is a new segment, the focus of which is context and user empowerment. The goal is to help the user control their level of interruption by providing automated control of calls based on context.

Traditional PBX platforms and many of today's generation of IP PBX platforms, assume the use of a “dumb” endpoint As these products evolve, more and more of the capabilities of the end point are being exploited, such as presence. Sales of IP enabled PBXs are expected to exceed those of traditional PBX in 2005. IP enabled PBXs are convergence products designed to exploit the potential of single network merged data and voice This market will likely shift away from proprietary architectures and move decisively to SIP, despite the fact that most of the vendors today are delivering either proprietary MGCP or H.323 solutions. Nonetheless, the invention is applicable to all of these environments. As well, the system and method of the invention may be offered as a stand-alone offering independent of the underlying communication system, or integrated with it.

Table 2 illustrates how each of the elements required to deliver Boomerang's core feature set of call routing and filtering, map onto the components described in the architecture.

The “Basic system” activity consists of the partial activities completed from each of the subsystem activities including: Rules Engine/Store, Context Provider Service, Exchange Adapter; Python Extension modules and the User Interface tasks. By partial, we mean the activities start at kick-off and only the minimal features required for the end-to-end major tasks are implemented.

Exemplary needs satisfied by the invention are shown in Tables 2 and 3.

Market Trends

Trend: Convergence of Cellular/VoIP/WiFi.

Single chipset VoIP solutions have already begun to emerge, making cost effective SIP phones possible The following developments are expected in the marketplace:
2005—The first WiSIP chipsets will hit the market. These chips will make cheap, cordless SIP phones possible.
2006—The first CelluLAN chipsets will hit the market. These chips will make cheap dual-mode cellular/WiFi SIP phones possible.
2007/2008—Business people will be starting to using cellular handsets instead of desktop phones. By 2010 or 2011 the cordless phone, and low end SIP phone markets will be dead, replaced by dual mode cellular/WiFi devices. The system and method of the invention is compatible with all of these.

Trend—Dis-aggregation

The old model of the telephone network is rapidly coming apart, due to a combination of technological forces, and deregulation. Whereas in the past, businesses would purchase services from a single vendor, usually the incumbent carrier, in the future three service businesses will exist—PSTN connectivity, directory, and applications/services—and businesses will not necessarily have to purchase all three from one vendor. Most businesses will choose to outsource PSTN connectivity, for instance while keeping applications internal. Specifically:
Pent-up demand exists for hosted services. Currently, the majority of businesses are purchasers, and owners of premise based equipment. Amongst small businesses, 48% have indicated a desire outsource telecommunications.
An explosion of “bring your broadband” alternate carriers, typified by Vonage, has come into the market.
Multiple vendors have come to market to offer ENUM services ENUM is the directory standard which bridges PSTN and VoIP numbers.
Alternate carriers are beginning to relax their restrictions on which equipment can be attached to their networks, further disaggregating the value chain.

The invention supports the system of IP PBX, SIP Server, and hosted IP PBX vendors, such as Natural Convergence, and service providers offering hosted IP PBX services like Covad. Although the market hype around the death of the RBOCs sells papers well, it is not likely to persist long term.

Boomerang Client

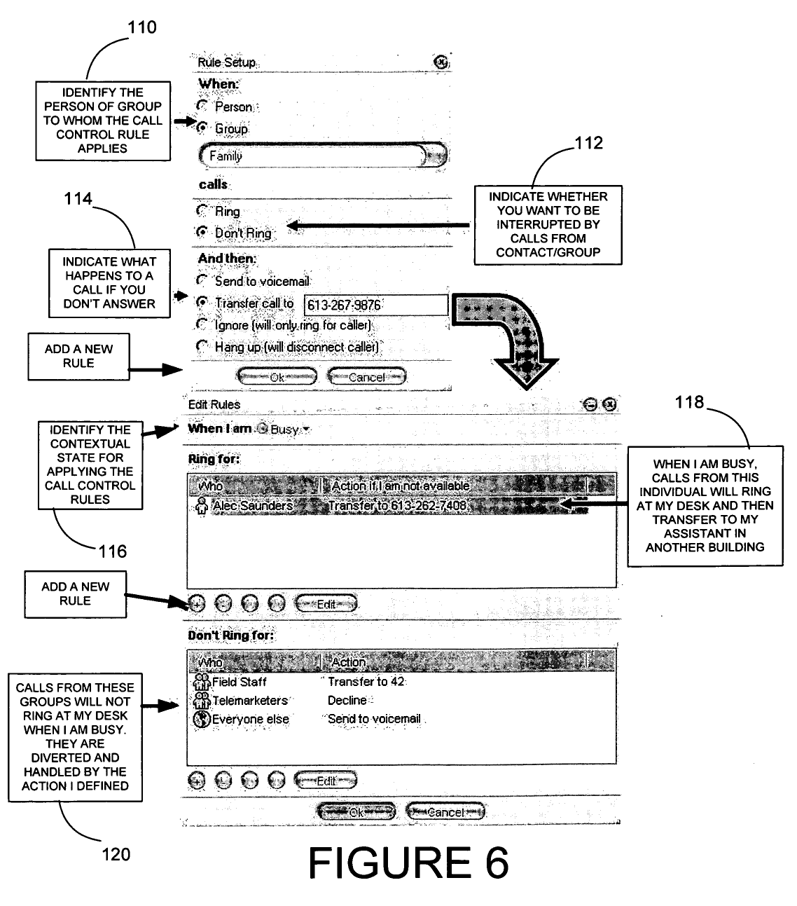

Call control rules are defined through a simple user interface; a scripting language is not required. FIG. 6 Defining Call Control Rules with the Boomerang Client illustrates how Boomerang's client interface is used to define a typical set of call control rules.

As shown in FIG. 6, a graphic user interface can be provided with fields for:
identifying the person or group to whom the call control rule applies 110;
indicating whether you want to be interrupted by calls from the contact/group 112;
indicating what happens to the call if you do not answer it, such as sending it to voicemail, transferring it to another telephone number, ignoring it, or hanging up 114;
identifying the contextual state for applying the call control rules 116;
identifying persons or groups that the telephone will ring for, and the action that will occur if I am not available 118; and
identifying persons or groups that the telephone will NOT ring for when I am busy, and the action that will occur 120.

Rules can be defined a-priori or they can be defined in real time as calls come in. Furthermore, the rules definition interface can integrate address book features from existing business applications to make rules creation even easier.

Boomerang continuously monitors the user's contextual state via the context adapters that are set up to listen for relevant contextual changes and automatically invokes the appropriate call control rules defined by the user. For example, the rule set being defined in the figure above will only be invoked when Boomerang detects that the user's presence has changed to a “Busy” state. Boomerang determines many of the contextual state criteria by collaborating with calendaring features of existing business applications and by monitoring the user's SIP messages. The user can also change context manually. Boomerang also optionally publicizes the user's presence making it easier for the user's contacts to determine the best time to call.

Based upon the rules defined by the user; Boomerang will route calls to any handset, SIP User Agent, voice mail, IVR, queue, or designee, or will reject the call.

Software Architecture

The software of the invention was developed in the following modules:
Server infrastructure—servicing requests, worker threads Services API infrastructure (xml-rpc/soap)
Server configuration store, read/write
Server Logging (actions, errors)
SIP Stack Wrapper
SIP Redirect Server
SIP Presence Server
User Management (add, remove, change password, etc.)
Abstract Context Source Adapters Exchange Source Adapter
Context Provider Service includes store
Rules Store
Rules Execution Engine
Rules Upload Service/Rules Download Service (for client editing)
Global rules (affect all users)
SIP Proxy
Presence Aggregator service
Boomerang Client
Rules Editing User Interface
Presence Control with the server
Settings Dialog
Setup
Authentication
Global rule editing mode
Server Management Console (Admin Client)
setup
User Interface
Communication to server/authentication
feature provisioning
server configuration wizard
Debug Console
Web Application:

Provides all the functionality of the Boomerang client application through a web application that can be used through any standard Web browser such as Microsoft's Internet Explorer, Firefox or any other standard web browser

Additional Features

The architectural design described in this document supports Boomerangs core feature of call control based on contextual awareness. It also enables support for a number of additional features as well:
Standards—Boomerang is preferably built entirely on open standards. Boomerang can handle any kind of SIP call, be it a simple voice call or a richer video call
Presence—Boomerang can publicize the user's presence making it easier for the user's contacts to determine the best time to call. In addition, Boomerang monitors presence “Watchers”—those users authorized to “see” the presence of Boomerang users. As a result, Boomerang provides the user with the ability to be selective about who sees their presence, along with the ability to publicize a different presence state with different levels of granularities to different users and circumstances under which the presence state changes.
Smart Rule Sets—Call control rules can be defined a-priori and they be defined in real time as calls come in. Furthermore Boomerang can learn what to do based upon the users actions and help the user define rules. For example if the user consistently transfers a particular caller to an extension each time, Boomerang can help the user define a rule that will do it automatically.

Finally, corporate and global rule sets are supported. For example, a corporate wide rule could be created for a VIP client that ensures they are never directed to voicemail.
Data Share and Exchange—Boomerang integrates with common business applications. The integration enables the applications to share and exchange data. For example, Boomerang can access the address book features of an existing third party application making it easier for the user to establish outgoing calls and to identify the source of incoming requests. Similarly, third party applications can access the data stored in Boomerang's communication log, including notes taken during communication sessions.
Single Number Reach—Boomerang's rich call filtering rules engine enables the user to publicize a single contact address for all of their contacts to use. This address will never change, and the Boomerang user has complete control over the actual device that will receive the call (desk phone, mobile phone, voicemail agent), and which contacts can get through to the user directly.
Relationship and Social Network Engines—Boomerang's architecture can incorporate contextual data from relationship discovery tools like “Spoke” and other social networking engines. For example, Spoke discovers relationships throughout an organization on the basis of email traffic between individuals. Incorporating this capability into Boomerang will allow for much richer discovery of important relationships between coworkers This sort of data could enable Boomerang to attribute higher priority to an individual based shared relationships and projects.
Operator Console—Boomerang can extend to provide operator consoles, and other specialized contextually-aware user agents.
In/Out Board—Opportunities also exist to build shared applications around the script generation tools. For example, an in-out board showing the presence and calendar information of everyone in an office, with administrators capable of updating call control rules and calendars.
Device Independence—Boomerang's call control and filtering features work with any SIP compliant User Agent, whether a hardware handset device or a soft-phone.

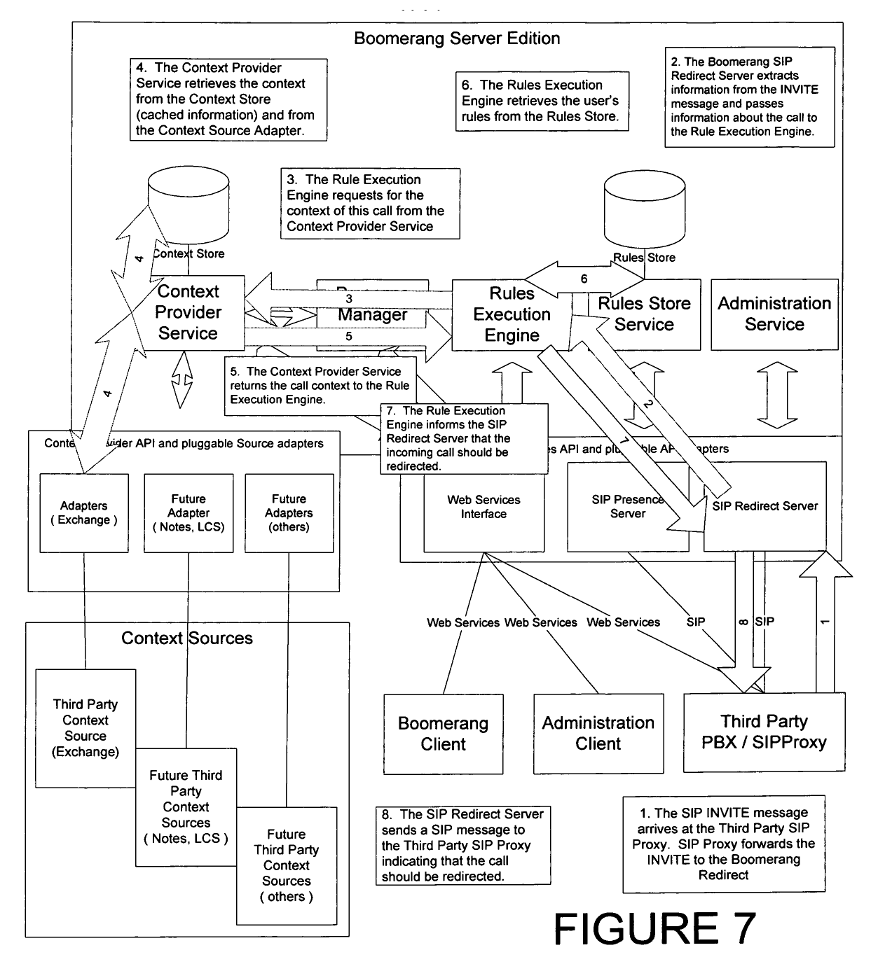

FIG. 7 presents a process flow diagram of the “incoming call” use cases described hereinafter.

Use Cases/Incoming Call/Basic Scenario
1. The use case starts when an outside user initiates a call with the Boomerang user
2. The SIP INVITE message arrives at the Third Party SIP Proxy
3. The Third Party SIP Proxy forwards the INVITE message to the Boomerang Redirect SIP Server
4. The Boomerang SIP Redirect Server extracts information from the INVITE message and passes information about the call to the Rule Execution Engine
5 The Rule Execution Engine requests for the context of this call from the Context Provider Service
6. The Context Provider Service retrieves the context from the Context Store (cached information) and from the Context Source Adapter. The call context includes information about the Boomerang user and about the caller.
7. The Context Provider Service returns the call context to the Rule Execution Engine.
8. The Rules Execution Engine retrieves the user's rules from the Rules Store.
9. The call context indicates that the user is “out of the office” and that the caller is an “important customer”. Based on the call context and rules defined by the user the Rule Execution Engine determines that the call should be redirected to the user's mobile phone.
10. The Rule Execution Engine informs the SIP Redirect Server that the incoming call should be redirected to the user's mobile telephone number.
11. The SIP Redirect Server sends a SIP message to the Third Party SIP Proxy indicating that the call should be redirected.
12. The Third Party SIP Proxy redirects the call to the user's mobile number
13 The user's mobile rings and the important customer has a conversation with the user.
14 The use case ends.

Use Cases/Incoming Call/Alternate Scenarios

Send unimportant call to Voice Mail
1. Repeat steps 1 to 8 in the Basic Scenario.
2. The call context indicates that the user is “busy in a meeting” and caller is a “friend” “wanting to set up a game of golf”. Based on the call context and the rules defined by the user the Rules Execution Engine determines that the call should be sent to the user's voice mail.
3 The Rules execution engine tells the SIP Redirect Server to send the call to the user's voice mail number.
4. The SIP Redirect server sends SIP message to the third party SIP Proxy indicating that the call should be sent to the user's voice mail.
5. The Third Party SIP proxy redirects the call to the user's voice mail box.
6. The caller leaves a message for the user indicating that he/she would like to play golf on the weekend with the user.
7. The Use Case Ends.

Use Cases/Incoming Call/Important call gets forwarded to During a Meeting
1. Repeat steps 1 to 8 in the Basic Scenario.
2. The call context indicates that the user is “busy in a meeting” located in the “Board Room” and caller is a “Co-worker” who is calling with “important information regarding the meeting”. Based on the call context and the rules defined by the user the Rules Execution determines that the call should be redirected to the phone located in the “Board Room”.
3. The Rules execution engine informs the SIP Redirect Server to redirect the call to the phone in the Board Room.
4. The SIP Redirect server sends SIP message to the third party SIP Proxy indicating that the call should be redirected to the Board Room.
5. The Third Party SIP proxy redirects the call to the phone in the Board Room.
6 The phone in the Board Room rings and the co-worker passes on the crucial information.
7. The Use Case Ends.

Use Cases/Incoming Call/Call Gets Declined
1. Repeat steps 1 to 8 in the Basic Scenario.
2. The call context indicates that the caller is an “ink jet cartridge sales man” Based on the global rules defined by the company, the Rules Execution Engine determines that the call should be declined.
3. The Rules execution engine informs the SIP Redirect Server that the call should be declined.
4. The SIP Redirect server sends a SIP message to the Third Party SIP Proxy indicating that the call should be declined.
5. The Third Party SIP Proxy declines the call.
6. The “ink jet cartridge sales man” simply hears a dial tone.
7. The Use case ends

Use Cases/Incoming Call/Call Goes Through
1. Repeat steps 1 to 8 in the Basic Scenario.
2. The call context indicates that the user is “available” and the caller is the user's “wife”. Based on call context and the user's defined rules the Rules Execution Engine determines that the call should ring on the user's desk phone.
3. The Rules execution engine informs the SIP Redirect Server to let the call ring on the desk phone.
4. The SIP Redirect Server sends a SIP message indicating the user's desk phone should ring.
5. The user's desk phone rings and the user has a conversation with his wife.
6. The Use Case Ends.

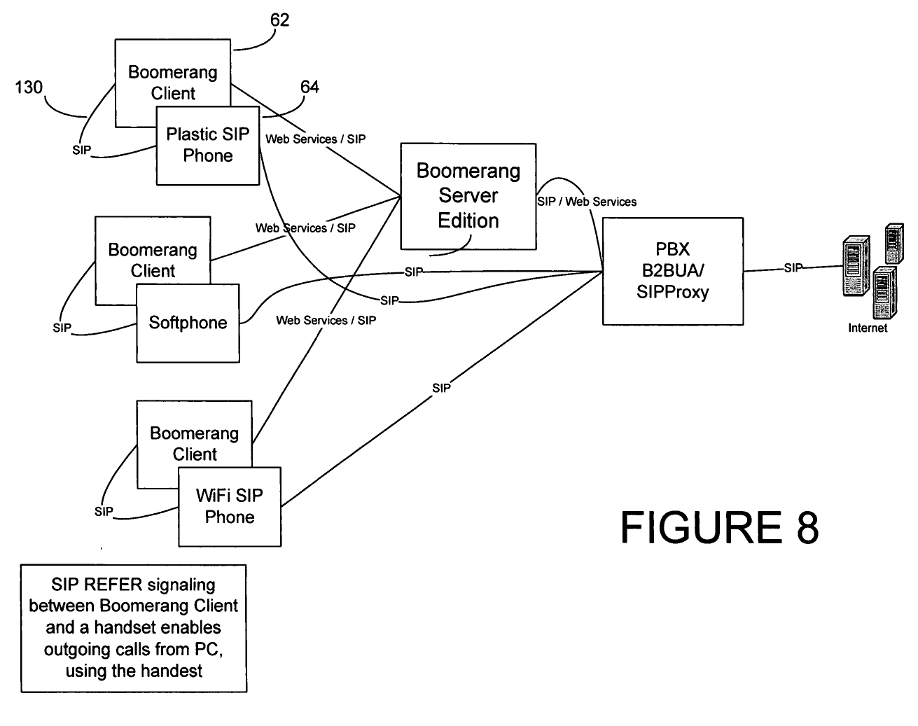

FIG. 8 presents a process flow diagram of the “Placing a call from the Boomerang Client” use case described hereinafter.

Basic Scenario
1. On Alice's desk sit a computer and an IP phone. She would like to place an outgoing call using the plastic IP phone 64, to a contact stored in her PC, without the need to dial the number into the phone.
2. The Boomerang Client 62 integrates with her Personal Information Management system, and allows her to dial by name through a Make a Call toolbar, docked to her Windows taskbar.
3. As she starts typing in the name of the contact she wishes to call, auto-completion choices are displayed. She then uses the arrow keys on her keyboard to pick the right contact, and presses the enter key.
4. Using history and context (including presence) information, Boomerang picks the best number from the contact to use, and instructs the phone on Alice's desk to place the call using the SIP REFER method 130.
5. She picks up her handset, and hear's the remote end ringing.

Alternate Scenarios

No Support For Out-of-dialog REFER
1. Bob also would like to place calls using Boomerang's PIM integration, but his desk phone doesn't support out-of-dialog REFERs. It does however support indialog REFERs.
2. Bob proceeds to pick Carol from his contact database, but would like to phone her directly on her mobile, because he knows she's on the road today. Once he's chosen Carol's entry in the auto-complete list, he clicks the Go button on the right of the field. A menu showing all numbers available for Carol is shown He picks Mobile.
3. Boomerang then rings Bob's desk phone. He picks up, and as soon as he does, gets transferred to Carol through a SIP REFER, and hear's the remote end ring

Support for Call from Clipboard
1. Dennis would like to place a call to a number he sees on a web page. He selects the number on the page, and presses Ctrl-C to copy the text to his PC's clipboard. He then right clicks on Boomerang's icon in his taskbar, and selects Phone from Clipboard. His desk phone immediately dials the number for him.

Viewing and Editing Rules

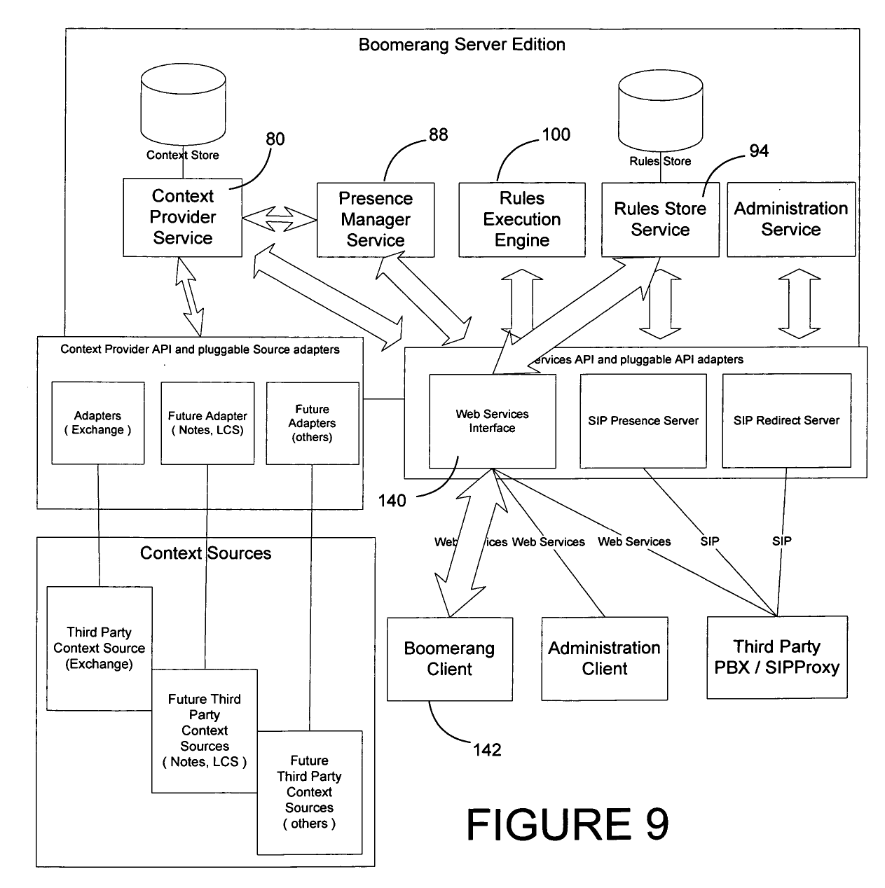

FIG. 9 presents a process flow diagram of the “Viewing and Editing Rules” use cases described hereinafter. The Context Provider Service 80 exposes context from heterogeneous source in a consistent manner, so other services can easily get access to relevant context information. Potential context sources are Mail, Contacts, Calendar, Time-of-day, presence clouds like LCS, LDAP directories, location services. The Presence Manager Service 88 acts as a presence source, and exposes the user's presence to the presence cloud, based on heuristics and context data. The granularity of the presence data exposed to external SIP users is controlled through privacy policies.

The Rules Store Service 94 and the Rules Execution Engine 100 act as the main call processing elements. They allow the user to set discretionary call handling policies, and also allow the administrator to set discretionary and mandatory site policies. The Rules Store Service 94 can get all of the rules that apply to a specific user. It can also update the set of rules that are specific to a user (i.e. non-global rules)

The web services interface 140 exposes some of the Boomerang Server Edition services to client software. In this scenario, getting and setting rules. The Boomerang Client 142 is where rules are viewed and edited by the user.

Basic Scenario
1. The use case starts when the user launches the Rule Editor dialog on the Boomerang Client
2. The client requests the rules for the current user from the Boomerang Server.
3. The web service request gets routed to the Rules Store Service on the server which pulls all of the rules for the specified user from the Rules Store. The rules include those that are specific to the user and the global rules that apply to all users
4 The Rule Store Service replies to the client with the rules.
5. The Rule Editor dialog displays the rules for the current context.
6. The rules that are specific to the user can be viewed and edited. The global rules can only be viewed.
7. The user presses the OK button on the Rule Editor dialog.
8. The client serializes the rules that are specific to the user (i.e. non-global rules) and sends them to the server using web services.
9. The server receives the web service request and routes it to the Rules Store Service.
10. The Rules Store Service updates the Rules Store, replacing the previous rules for the user with the new ones.
11. The Rule Editor dialog closes on the client.
12. The use case ends.

Cancel Scenario
1. The scenario begins when the user presses the Cancel button (rather than the OK button) on the Rule Editor dialog.
2. The client does not serialize the rules or send them to the server.
3. The Rule Editor dialog closes on the client.
4. The scenario ends.

The User Edits a Rule
1 The scenario begins when the user double-clicks on a rule or selects it and presses the edit button. The user cannot edit a global rule.
2. A Rule Setup dialog is displayed. It reflects the current settings for the rule being edited (i.e. who it applies to and what action is taken).
3. The user can change the conditions under which the rule will apply (e.g. Identity of caller).
4. The user can change the action to take (e.g. ring, decline, and redirect).
5. The user presses the OK button on the Rule Setup dialog to update the local copy of the rules. The changes will not be finalized until the user presses the OK button on the Rule Editor dialog.
6. The scenario ends

The User Adds a Rule
1. The scenario begins when a user presses the add button.
2. A Rule Setup dialog appears with default rule settings
3. The user sets the conditions under which the rule will apply (e.g. Identity of caller).
4. The user sets the action to take (e.g ring, decline, and redirect).
5. The user presses the OK button on the Rule Setup dialog to update the local copy of the rules. The changes will not be finalized until the user presses the OK button on the Rule Editor dialog.
6. The scenario ends.

The User Deletes a Rule
1. The scenario begins when a user presses the delete button or selects a rule and presses the DELETE key. The user cannot delete a global rule.
2. The deleted rule is removed from the local copy of the rules The change will not be finalized until the user presses the OK button on the Rule Editor dialog
3 The scenario ends.

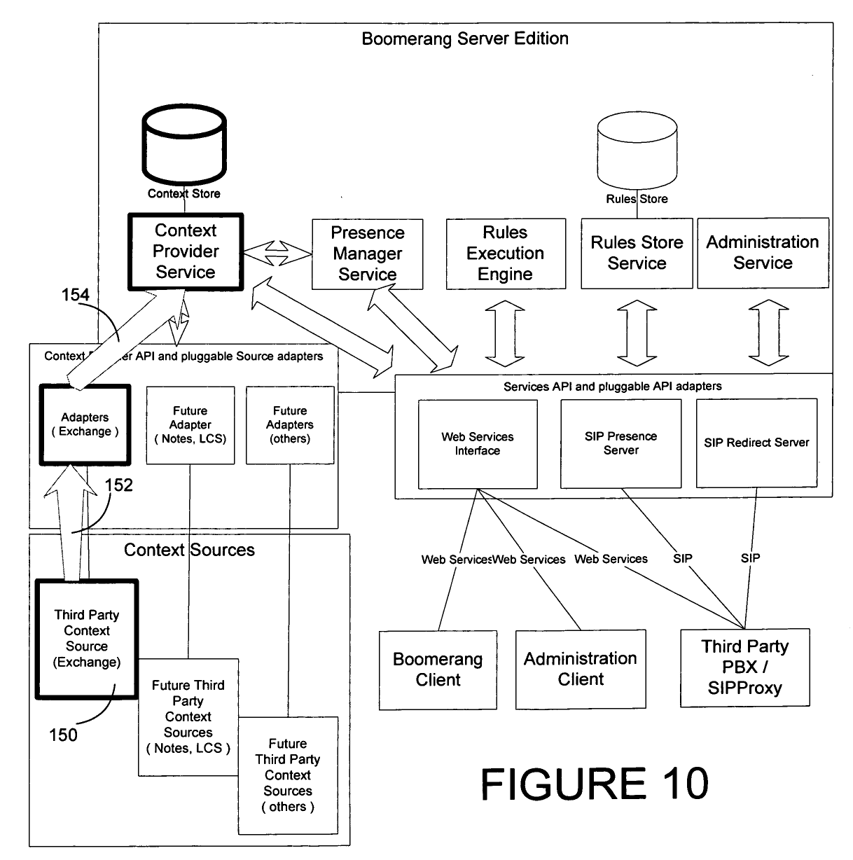

FIG. 10 presents a process flow diagram for the “Process Context Updates from a Wireless” use case. In short, the User updates his context source via the usual client, or wireless client 150 The Context source then notifies the context adapter of the change 152. The Adapter then notifies the Context provider of the change, and the context provider service updates the context for the user 154.

Device (Blackberry)
1. The use case starts when the user updates a Contextual Element (e.g. Their calendar) on their wireless device (e.g. A Blackberry),
2. The synchronization mechanism intrinsic in the wireless device (Blackberry) applies the change to the user's Context Provider (e.g. MS Exchange),
3. The Context Provider (MS Exchange) updates itself accordingly (e.g. updates its calendar),
4. The Context Provider Service receives an event from Context Provider (MS Exchange) that describes the update,
5. The Context Provider Service informs the Presence Manager service,
6. The Context Provider service re-computes the user's Contextual State,
7. The Rules Execution engine applies call control rules that are appropriate for the new contextual state the next time a call comes in,
8. The use case ends.

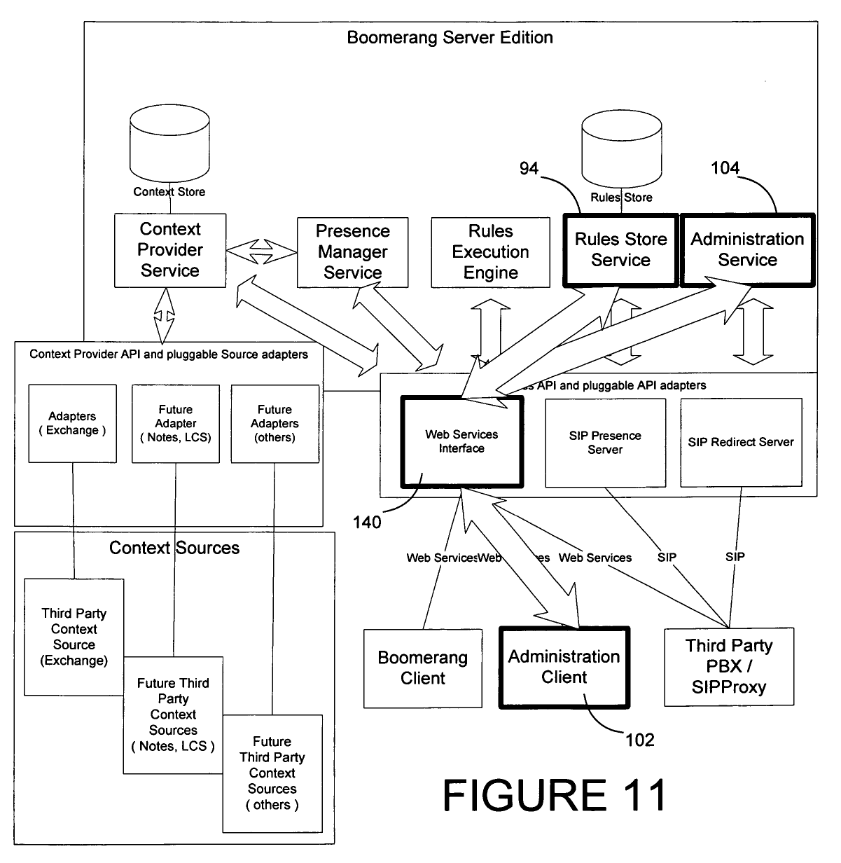

FIG. 11 presents an exemplary process flow diagram of the “Administration Console Interaction” use cases described hereinafter.

The Admin Client 102 is where all user administrative tasks are performed, as well as the editing of global rules. The web services interface 140 exposes some of the Boomerang Server Edition services to client software; in this scenario Adding, Removing & Editing users, as well as getting and setting the Global Rules. The Rules Store Service 94 provides the implementation of getting and setting the global rules for the web services interface, and the Administration Service 104 provides the User manager service through the web services.

Basic Scenario
1. The use case starts with the administrator launching the Boomerang Server Admin Client
2. The client UI launches, presenting the admin with a logon
3. The administrator authenticates with their login id and password
4. The client User Interface presents the administrator with the options—Edit global rules, Add User, Remove User, Edit User
5. The user chooses Edit Global Rules
6. The current global rules are downloaded from the server via the web services interface.
7. The admin user is presented with the rules editing User Interface, this is the same User Interface as used in the Boomerang Client. The current rules are displayed in the User Interface
8. The admin user adds a new rule to forward all calls outside of business hours to voicemail
9 The admin user finishes editing the rules and saves
10. The admin client pushes the rules up to the server via web services, where they immediately replace the previous global rules for all incoming calls.
11. The admin user shutdowns the client, the client application exits.
12. The use case ends

Add User
1. Repeat steps 1 to 4 in the Basic Scenario.
2. The admin user chooses add user
3. The admin user is presented with User Interface to specify the details for the user. There is a minimum set of info which is required to add a user and the ‘add’ button is not enabled until that minimum is met.
4. The user info includes name, userid, context source locations
5. When the admin user chooses to ‘add’ user the information is pushed to the Boomerang server using the web-services.
6 On server, a new account is created, after checking for duplicate users. Any context sources provided are configured from the info provided.
7 If the action is successful the add user dialog dismisses.
8. If the add user is not successful, the admin user is given error information, and returned to the add user dialog to try again.
9. The use case ends.

Delete User
1. Repeat steps 1 to 4 in the Basic Scenario.
2. The user chooses delete user.
3 The admin client requests a list of users from the boomerang server
4. The admin user selects a user from the list and chooses delete.
5. The delete request is sent to the Boomerang Server via the web services interfaces.
6. The server removes the user and all associated data from the server stores.
7. The client indicates successful deletion
8. The use case ends.

Edit User
1. Repeat steps 1 to 4 in the Basic Scenario.
2. The user chooses edit user.
3. The admin client requests the list of users from the Boomerang Server via web services.
4. The Boomerang server iterates over the user store, and returns a list of all user ids and user names
5. This list is presented to the admin user. The admin user selects a user and chooses to edit.
6. The admin client requests the user details via web services.
7 The Boomerang server pulls the details from the user store and returns all the editable details.
8. The admin user changes the details in the User Interface and selects Save
9. The admin client pushes the details to the Boomerang Server via web services where they are validated and if valid, updated in the store. If not valid, error information is returned.
10. If successfully save the user detail dialog closes, if not the admin user is given a chance to make changes and try again
11 The use case ends.

For example, the method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system provided with means for executing these steps. Similarly, an electronic memory medium such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

The invention could, for example, be applied to computers, smart terminals, personal digital assistants and Internet-ready telephones. Again, such implementations would be clear to one skilled in the art, and do not take away from the invention.

The present invention has been described with regard to one or more embodiments. However, it will be apparent to persons skilled in the art that a number of variations and modifications can be made without departing from the scope of the invention as defined in the claims.

All citations are hereby incorporated by reference.

What is claimed is:

1. A method of routing real-time communications comprising the steps of:
establishing rules for a user;
responding to the receipt of a communication by:
determining the current contextual state of said user;
analyzing said communication, said current contextual state and said rules, and determining how said communication should be routed; and
routing said communication in accordance with said determination.

2. The method of claim 1 wherein said step of establishing rules comprises the steps of:
launching a rules wizard to present exemplary scenarios and options to said user; and
storing rules values identified by said user.

3. The method of claim 1 wherein said contextual criteria are selected from the group comprising:
Presence,
Day and Time,
Relationship to caller,
Current activity,
Who is calling,
What the call is about,
Importance of the call,
PC activity,
Communication history with caller,
Velocity of user (driving, running etc.),
Refer information (whether the call is being transferred by someone else),
Mood of user,
Ambient noise and,
Location of user.

4. The method of claim 1 in which said system includes cross-platform capability.

5. The method of claim 1 further comprising the step of integrating the functionality of existing business applications.

6. A telecommunications system comprising:
a telecommunications network;
a plurality of user communication interface devices; and
means for coordinating communications between said telecommunications network and said plurality of User communication interface devices, with consideration for the contextual state of said User.

7. The system of claim 6, further comprising means for enabling said End User to set up rules for governing communications.

8. A telecommunications system comprising:
a personal computer;
a remote server; and
a telecommunications network interconnecting said personal computer and said remote server;
said personal computer including a piece of client software operable to:
determine the current context of a user and rules established by said user; and
coordinate operation of various user communication devices in response to said current context and rules

9. The system of claim 8, further comprising an advanced heuristics algorithm for detection of communication routing patterns, said advanced heuristics algorithm being operable to use pattern detection to automatically (with user's consent) modify the user's rules to improve the communication handling.

10. The system of claim 9, further comprising an Algorithm/Heuristics/AI module for examining the communication history between the user and other participating characters to make more intelligent communication routing decisions, said participating characters comprising the caller or someone the user is currently communicating with.

11. The system of claim 9, further comprising a hierarchy concept of rules and policies that allow for global and individual rules processing.

12. The system of claim 9, designed with a context plug-in architecture that facilitates the introduction of new sources of context within the system.

13. The system of claim 9, further comprising an advanced rule conflict algorithm that accommodates conflicting rules and ensures that expected behavior is maintained by the system.

14. The method of claim 1 wherein said step of routing comprises the step of diverting real time communications away from said user; that are not relevant to said user's current activities.

15. The method of claim 1 wherein said step of routing comprises the steps of locating said user and forwarding teal time communications to said user, that are important to said user's current activities.

16. The method of claim 1 further comprising the steps of:
in response to a request to change said established rules, being received from said user:
launching said rules wizard, populating fields in said rules wizard with said stored rules values;
storing new rules values identified by said user; and
re-calculating the values of stored presence responses.

17. The method of claim 1 wherein said user's available communications devices include at least one selected from the group consisting of:
Cellular telephone;
Personal digital assistant;
Personal computer;
Internet-ready telephone;
Voice over IP telephone;
Television set-top box.

18. The system of claim 8, further comprising means for enabling said End User to set up rules for governing communications.
